(19) United States
(12) Patent Application Publication
(10) Pub. No.: US 2014/0353477 A1
(43) Pub. Date: Dec. 4, 2014

(54) OPTICAL ENCODER

(71) Applicant: The Cleveland Electric Laboratories Company, Twinsburg, OH (US)

(72) Inventors: Scott V. Johnson, Scottsdale, AZ (US); Mike McNeilly, Gilbert, AZ (US)

(21) Appl. No.: 14/289,948

(22) Filed: May 29, 2014

Related U.S. Application Data
(60) Provisional application No. 61/828,458, filed on May 29, 2013.

(51) Int. Cl. G01D 5/34

(52) U.S. Cl. CPC G01D 5/34
USPC 250/231.1

(57) ABSTRACT

An optical encoder includes: a first wavelength division multiplexer; a first set of optical launches including at least one optical launch, operatively connected to the first multiplexer; and an encoder plate including at least one patterned track; wherein each optical launch of the first set is positioned to direct light at the corresponding patterned track.

### I. BACKGROUND

This invention pertains to the art of optical encoders. Encoders are used to determine position and motion of objects. Linear encoders measure motion or position along a substantially linear path, and rotational encoders measure motion or position along a substantially circular path. An optical encoder transmits light to one side of an aperture plate that has apertures spaced in a unique pattern throughout the path of travel. On the other side of the aperture plate, an array of photodetectors senses the absence or presence of light. The photodetector array generates an electrical signal based on the light sensed coming through the apertures, and the electrical signal is transmitted to other devices that read the signal and correlate it with the position or motion of the object whose position or motion is encoded. To have a completely optical encoder, this apparatus and method are disclosed.

### II. SUMMARY

In accordance with one aspect of the present invention, an optical encoder includes: a first wavelength division multiplexer; a first set of optical launches including at least one optical launch, operatively connected to the first multiplexer; and an encoder plate including at least one patterned track; wherein each optical launch of the first set is positioned to direct light at the corresponding patterned track.

In accordance with another aspect of the present invention, a system includes: a light source; an optical encoder connected to the light source by an optic fiber; and a detector connected to the optic fiber; wherein the optical encoder includes: a first wavelength division multiplexer; a first set of optical launches including at least one optical launch, operatively connected to the first multiplexer; and an encoder plate including at least one patterned track; wherein each optical launch of the first set is positioned to direct light at the corresponding patterned track; wherein either a) the encoder plate is stationary and the first set of optical launches is movable with respect to the encoder plate, or b) the first set of optical launches is stationary and the encoder plate is movable with respect to the first set of optical launches; wherein an associated movable object is secured to, and moves proportionally to, one of the encoder plate and the first set of optical launches, whichever is movable; wherein the at least one patterned track includes reflective and absorptive surfaces that reflect or absorb, respectively, light directed from each corresponding optical launch; wherein the first multiplexer includes: a first port; and a second port including at least one channel, wherein the number of channels is equal to the number of optical launches; wherein the first multiplexer is configured to: a) receive a beam of light in the first port; b) separate the beam of light into a number of light slices, where the number of light slices is equal to the number of channels; c) transmit each light slice out of the second port to the corresponding optical launch; d) receive each reflected light slice in the second port from the corresponding optical launch; e) recombine the reflected light slices into a recombined beam of light; and f) transmit the recombined beam out of the first port; wherein the light source is configured to generate the beam of light that is received by the first port of the first multiplexer of the optical encoder; and wherein the detector is configured to: a) receive the recombined beam of light that is transmitted out of the first port of the first multiplexer of the optical encoder, and b) determine from the recombined beam a position or movement of the associated movable object.

In accordance with still another aspect of the present invention, a system includes: a light source; an optical encoder connected to the light source by a first optic fiber; and a detector connected to the optical encoder by a second optic fiber; wherein the optical encoder includes: a first wavelength division multiplexer; a second wavelength division multiplexer; a first set of optical launches including at least one optical launch, operatively connected to the first multiplexer; a second set of optical launches including at least one optical launch, operatively connected to the second multiplexer; and an encoder plate including at least one patterned track; wherein each optical launch of the first set is positioned to direct light at the corresponding patterned track; wherein either a) the encoder plate is stationary and the first set of optical launches is movable with respect to the encoder plate, or b) the first set of optical launches is stationary and the encoder plate is movable with respect to the first set of optical launches; wherein an associated movable object is secured to, and moves proportionally to, one of the encoder plate and the first set of optical launches, whichever is movable; wherein the at least one patterned track includes transmissive and absorptive areas that transmit through the encoder plate or absorb, respectively, light directed from each corresponding optical launch of the first set of optical launches; wherein each optical launch of the second set is positioned to receive transmitted light from the corresponding patterned track of the encoder plate; wherein: a) if the first set of optical launches is stationary, then the second set of optical launches is stationary; and b) if the first set of optical launches is movable, then the second set of optical launches is movable with the first set of optical launches; wherein the first multiplexer includes: a first port; and a second port including at least one channel, wherein the number of channels is equal to the number of optical launches of the first set of optical launches; wherein the first multiplexer is configured to: a) receive a beam of light in the first port; b) separate the beam of light into a number of light slices, where the number of light slices is equal to the number of channels; and c) transmit each light slice out of the second port to the corresponding optical launch of the first set of optical launches; wherein the second multiplexer includes: a third port including at least one channel, wherein the number of channels is equal to the number of optical launches of the second set of optical launches; and a fourth port; wherein the second multiplexer is configured to: a) receive each transmitted light slice in the third port from the corresponding optical launch of the second set of optical launches; b) recombine the transmitted light slices into a recombined beam of light; and c) transmit the recombined beam out of the fourth port; wherein the light source is configured to generate the beam of light that is received by the first port of the first multiplexer of the optical encoder; and wherein the detector is configured to: a) receive the recombined beam of light that is transmitted out of the fourth port of the second multiplexer of the optical encoder; and b) determine from the recombined beam a position or movement of the associated movable object.

In accordance with yet another aspect of the present invention, a method includes the steps of: a) providing: a light source, an optical encoder, a detector, and a movable object; wherein the optical encoder includes: a first wavelength division multiplexer; a first set of optical launches including at least one optical launch, operatively connected to the first multiplexer; and an encoder plate including at least one patterned track; wherein each optical launch of the first set is positioned to direct light at the corresponding patterned track; wherein either a) the encoder plate is stationary and the first set of optical launches is movable with respect to the encoder plate, or b) the first set of optical launches is stationary and the encoder plate is movable with respect to the first set of optical launches; wherein an associated movable object is secured to, and moves proportionally to, one of the encoder plate and the first set of optical launches, whichever is movable; wherein the at least one patterned track includes reflective and absorptive surfaces that reflect or absorb, respectively, light directed from each corresponding optical launch; wherein the first multiplexer includes: a first port; and a second port including at least one channel, wherein the number of channels is equal to the number of optical launches; wherein the first multiplexer is configured to: a) receive a beam of light in the first port; b) separate the beam of light into a number of light slices, where the number of light slices is equal to the number of channels; c) transmit each light slice out of the second port to the corresponding optical launch; d) receive each reflected light slice in the second port from the corresponding optical launch; e) recombine the reflected light slices into a recombined beam of light; and f) transmit the recombined beam out of the first port; b) securing the movable object to one of the encoder plate and the first set of optical launches, whichever is movable; c) connecting the light source to the optical encoder by an optic fiber; d) connecting the detector to the optic fiber; e) generating the beam of light from the light source and transmitting the beam of light to the first multiplexer through the optic fiber; f) separating the beam of light with the first multiplexer into light slices; g) transmitting the light slices out of the first multiplexer through the first set of optical launches onto the encoder plate patterned tracks; h) absorbing into the encoder plate the light slices that are directed onto the absorptive surfaces of the encoder plate; i) reflecting back to the respective optical launches the light slices that are directed onto the reflective surfaces of the encoder plate; j) transmitting to the first multiplexer the reflected light slices from the first set of optical launches; k) recombining the reflected light slices into the recombined beam of light with the first multiplexer; l) transmitting the recombined beam out of the first multiplexer to the detector through the optic fiber; and m) determining with the detector a position or movement of the movable object based on the recombined beam.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a diagram of one embodiment of an optical encoder.

FIG. 2 is a perspective view of one embodiment of an encoder plate.

FIG. 3 is a diagram of one embodiment of an optical encoder.

FIG. 4 is a diagram of a sensing system using one embodiment of an optical encoder.

FIG. 5 is a diagram of another embodiment of an optical encoder.

FIG. 6 is a diagram of another embodiment of an optical encoder.

FIG. 7 is a partial front view of another embodiment of an encoder plate.

### IV. DETAILED DESCRIPTION

Referring now to the drawings wherein the showings are for purposes of illustrating embodiments of the invention only and not for purposes of limiting the same, and wherein like reference numerals are understood to refer to like components, FIG. 1 shows a diagram of one embodiment of an optical encoder 100. The optical encoder 100 shown in FIG. 1 is a reflective, rotational encoder 100. A light source 102 or emitter may generate a beam of light. The light generated by the light source 102 may travel along a fiber or optical channel to a wavelength-division multiplexer (WDM) 104. The WDM 104 may separate the light into narrow “slices” or channels of light, each slice having a specific wavelength signature. The WDM 104 may transmit through fibers each slice of light to a respective optical launch 106, which may focus and transmit the slice toward an encoder plate 108.

The encoder plate 108 may be secured to an object 110 that is being rotated along a rotation axis 112 in the indicated directions 114. Consequently, the encoder plate 108 may also rotate along the rotation axis 112 along with and in proportion to the object 110. Examples of the object 110 may include, but are not limited to, a shaft (including a motor shaft), a knob, and an axle. The encoder plate 108 may either absorb or reflect back the slice of light coming from each optical launch 106. The optical launches 106 may transmit through fibers the reflected light back to the WDM 104, which may combine the reflected slices into an encoded optical signal. The WDM 104 may transmit the encoded optical signal to a detector 116, which may correlate the signal with the position or motion of the object 110.

With continuing reference to FIG. 1, the light source 102 may be a narrowband light source 102, in one embodiment. In another embodiment, the light source 102 may be a superluminescent diode (SLD). In another embodiment, the light source 102 may output light having a sufficiently wide bandwidth or wavelength spectrum to be separated into the number of optical launches 106 used, considering the specific bandwidth of each optical launch 106. After determining the highest and lowest wavelengths of the optical launches 106 used, the bandwidth of the light source 102 may include the full width between these highest and lowest wavelengths.

The WDM 104 may be a dense wavelength division multiplexer (DWDM) 104 or a conventional/coarse wavelength division multiplexer (CWDM) 104, in alternative embodiments. In one embodiment, a DWDM 104 may break the light from the light source 102 into slices having a width of approximately 0.25-1.0 nm each. In another embodiment, a CWDM 104 may break the light from the light source 102 into slices having a width of approximately 3-10 nm each. The bandwidth of the light generated by the light source 102 may be greater if a CWDM 104 is used than if a DWDM 104 is used. A DWDM 104 may be more spectrally efficient than a CWDM 104 and may allow transmitting more signals. The WDM 104 may separate the source light into as many slices as the desired number of bits of resolution of the encoder 100. For example, a 16-division WDM 104 may create a 16-bit encoder 100. The embodiment of FIG. 1 shows a 5-bit encoder 100. The WDM 104 may act as a demultiplexer when it 104 separates the incoming light into a plurality of light slices. The WDM 104 may have two ports such that one port may transmit and receive a plurality of light slices through separate channels or inputs/outputs, and such that another port may transmit and receive a single beam of light that includes the plurality of light slices.

The encoder 100 may include as many optical launches 106 as the desired number of bits of resolution for the encoder 100. Each optical launch 106 in a set of optical launches may be configured and positioned so that its focal point is appropriately directed at the appropriate surface of the encoder plate 108 and that the respective slice of light is collimated, directed at, and focused on the appropriate surface of the encoder plate 108. In one embodiment, the optical launch 106 is constructed by cleaving an end of a fiber optic fiber. In another embodiment, the optical launch 106 is constructed by polishing an end of a fiber optic fiber. In another embodiment, the optical launch 106 is constructed by attaching or forming a lens (including an aspheric lens) at an end of a fiber optic fiber.

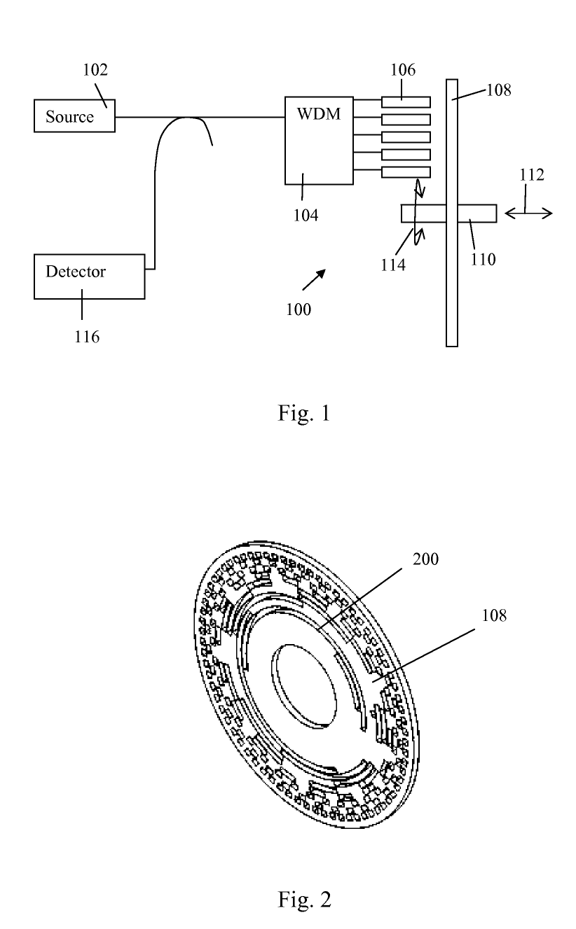

The encoder plate 108 may include grooves, channels, slits, or tracks 200, each corresponding to an optical launch 106, a channel of the WDM 104, and a bit of the encoder 100. The tracks 200 may be circular (in the directions of rotation 114) with increasing radii, each centered on the rotation axis 112, as shown in FIG. 2. Each track 200 may be patterned with absorptive and reflective surfaces that absorb or reflect the light slice, respectively. An absorptive surface may absorb into the encoder plate 108 the light slice coming from the corresponding optical launch 106. A reflective surface may reflect back to the optical launch 106 the light slice coming from the corresponding optical launch 106. A reflective surface may be designed such that it reflects light in the wavelength spectrum corresponding to its optical launch 106. The absorptive and reflective surfaces may correspond to an open or closed digital signal, respectively, or vice versa. The combination of tracks 200 may be patterned such that at each resolution of position of the encoder plate 108, the pattern looking radially across all of the tracks 200 is unique. As discussed previously, the encoder 100 may have as many bits of resolution as desired. In one embodiment, the encoder 100 may have the same number of optical launches 106 and tracks 200 on the encoder plate 108 as the number of bits of resolution desired. The tracks 200 may be patterned such that the encoder plate 108 is coded in a binary pattern or a Gray Code pattern, in alternative embodiments. In one embodiment, the encoder plate 108 may be wheel- or disc-shaped. In another embodiment, the encoder plate 108 may be wedge- or pie-slice-shaped. In alternative embodiments, the encoder plate 108 may have the shape of a pie having from 0 to 360 degrees.

When the slices of light are reflected from the encoder plate 108 back to the optical launches 106, the optical launches 106 may pass the reflected slices to the WDM 104. The WDM 104 may re-combine the slices into one light beam and return the beam to the single optical fiber. The WDM 104 may act as a multiplexer when it 104 combines the incoming light slices into one light beam.

The detector 116 may be located in proximity to the light source 102 in one embodiment. In another embodiment, the light source 102 and the detector 116 may be located apart from each other. The detector 116 may receive the incoming light, may detect the presence of discrete wavelength bands that correspond to the reflective track pattern on the encoder plate 108, and thus determine the position or motion of the object 110. The detector 116 may construct a digital word that corresponds to the angular position of the encoder plate 108.

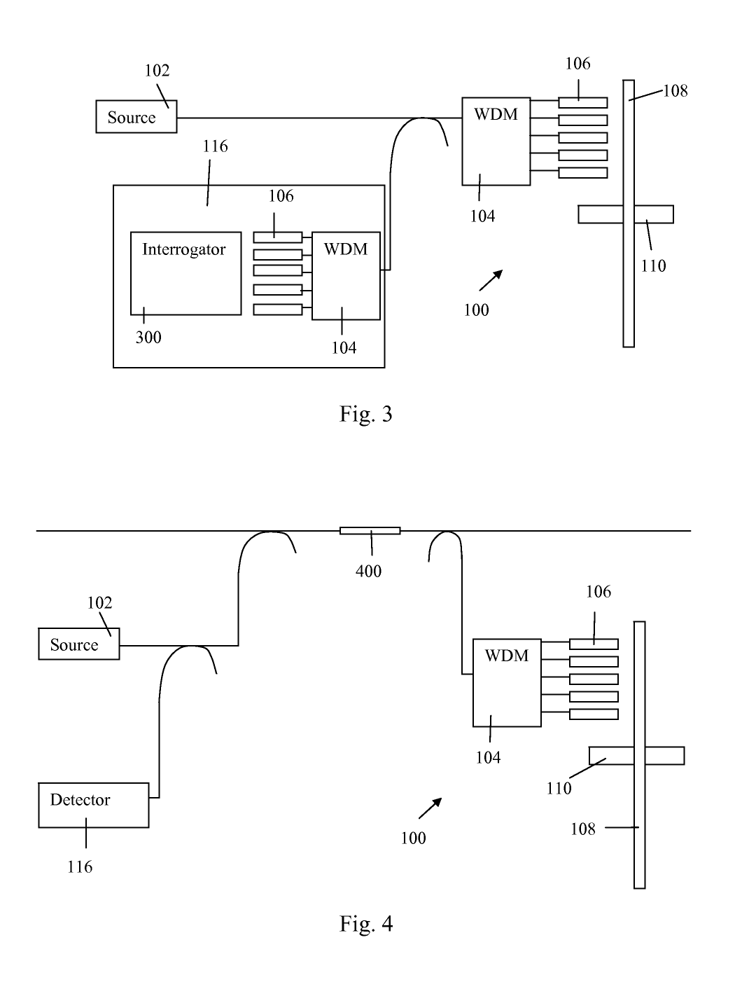

FIG. 3 shows a diagram of an encoder 100 with a specific detector 116. When the encoder plate 108 reflects certain slices of light back to the optical launches 106 and these slices are re-combined in the WDM 104, the WDM 104 may send the combined light signal to another WDM 104 that separates the light into separate slices of light and sends the slices to respective optical launches 106. This may be done in a manner similar to that discussed previously. In one embodiment, the slices from the set of optical launches 106 may then be routed to a detector array for determining whether each track 200 of the encoder plate 108 is in the reflective or absorptive position.

In another embodiment, the slices from the optical launches 106 may be routed to an interrogator 300. Each bit of the encoder 100 may be routed to a channel in the interrogator 300. In one embodiment, the interrogator 300 may be a static interrogator 300. In another embodiment, the interrogator 300 may be a scanning interrogator 300, which may be one that may be used to interrogate fiber brag gratings (FBGs). In one embodiment, the interrogator 300 may be a scanning-interferometer type FBG interrogator. A static interrogator 300 may have a faster response time than a scanning FBG interrogator 300. An FBG interrogator 300 may scan the entire bandwidth from one end to the other end, which may require a certain amount of time (sweep time); in one embodiment, the scanning frequency may be between 1 Hz and 35 kHz. The encoder 100 may be used with such an FBG interrogator 300 if the sweep time is sufficient to capture the rate of change of the encoder 100. Whether an interrogator 300 is sufficient may depend on the scan speed of the interrogator 300 and the number of bits of the encoder 100, with a greater number of bits requiring a greater number of channels and a greater scan period to scan all of the channels. If high velocities or high rates of change are required of the encoder 100, a dedicated static interrogator 300 may be used.

The encoder 100 may be used with a dedicated light source 102, fiber, and a standalone detector 116, in one embodiment. In a dedicated system, the detection rate of change of the encoder 100 may be limited by the electronics of the detector 116. In another embodiment, the encoder 100 may be integrated into an existing optical fiber sensing system. FIG. 4 shows an example of a simple system. The encoder 100 may co-exist on the same fiber as other sensors 400, including FBGs, if the wavelengths do not interfere. In one embodiment, the encoder 100 may be integrated into an FBG sensor system (having an interrogator 300) without requiring its own new interrogator 300, and the existing interrogator 300 may also detect the signal from the encoder 100.

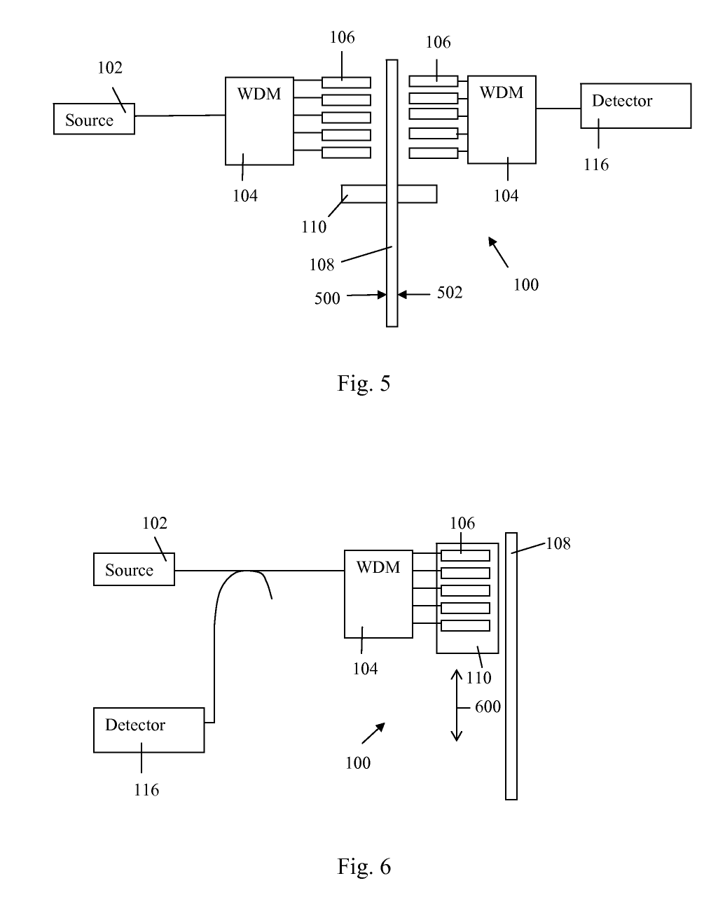

FIG. 5 shows a diagram of another embodiment of an optical encoder 100. The optical encoder 100 shown in FIG. 5 is a transmissive, rotational encoder 100. The light source 102, demultiplexing WDM 104, and optical launches 106 may operate as previously discussed with respect to the reflective encoder 100.

The encoder plate 108 may be similar to the one previously discussed with respect to the reflective encoder 100, except that the reflective surfaces may be replaced with transmissive areas. Thus, each track 200 of the encoder plate 108 of the transmissive encoder 100 may be patterned with absorptive and transmissive areas that absorb or transmit the light slice, respectively. A transmissive area may pass through the encoder plate 108 the light slice coming from the corresponding optical launch 106. The transmissive areas may be apertures or openings through the encoder plate 108, in one embodiment. In another embodiment, the transmissive areas may be transparent surfaces on the encoder plate 108. A transmissive surface may be designed such that it transmits light in the wavelength spectrum corresponding to its optical launch 106. The side of the encoder plate 108 that is facing the demultiplexing WDM 104 and optical launches 106 from which the slices come may be termed the input side 500. The opposite side of the encoder plate 108 may be termed the output side 502.

On the output side 502 of the encoder plate 108 may be positioned a set of optical launches 106 that may receive the transmitted light slices and transmit through fibers the slices to a multiplexing WDM 104. The WDM 104 may recombine the slices into one light beam and transmit the encoded optical signal through a fiber to a detector 116, as discussed previously. The output side optical launches 106 may be configured and positioned to correspond to, and match, the input side optical launches 106. The output side optical launches 106 and WDM 104 of this transmissive encoder may process the transmitted light slices like the optical launches 106 and WDM 104 process the reflected light slices in the reflective encoder 100. Thus, light slices coming from the input side optical launches 106 may be either absorbed by the encoder plate 108 or transmitted through the encoder plate 108 to corresponding output side optical launches 106. In alternative embodiments, the various functions and features discussed above with respect to the reflective encoder 100 may also apply to the transmissive encoder 100 as appropriate.

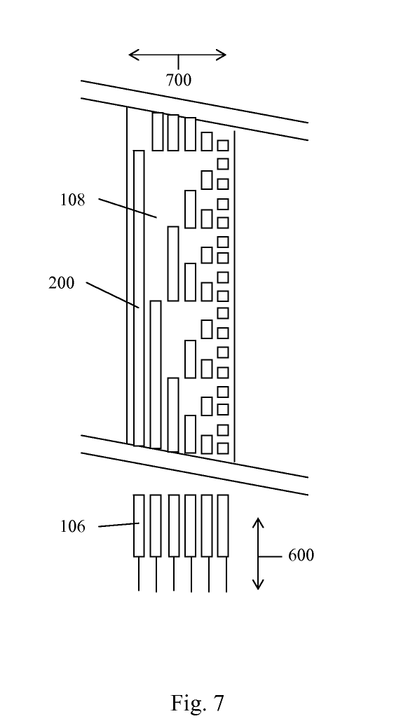

FIG. 6 shows a diagram of another embodiment of an optical encoder. The optical encoder 100 shown in FIG. 6 is a reflective, linear encoder 100. The various components may generally be similar to those previously discussed with similar functions and features. The encoder plate 108 may be a linear strip. The optical launches 106 may be secured to and move with the traveling object 110 in the directions of travel 600 (or travel axis) while the encoder plate 108 may be fixed and stationary. FIG. 7 shows a face of the encoder plate 108. The tracks 200 of the encoder plate 108 in this embodiment may be linear in the directions of travel 600, with one laterally next to another along the lateral axis 700. The combination of tracks 200 may be patterned such that at each resolution of position of the encoder plate 108, the pattern looking laterally across all of the tracks 200 is unique. The optical launches may be configured and positioned along the lateral axis 700 for the corresponding tracks 200. Alternative embodiments of linear encoders 100 may include reflective and transmissive encoders 100, as described above, and the operation of linear encoders 100 may be similar to that of rotational encoders 100 after being modified as described.

Embodiments may utilize fixed or stationary optical launches 106 with the encoder plate 108 being movable with respect to the optical launches 106. An example is shown in FIG. 1. Other embodiments may utilize a stationary encoder plate 108 with the optical launches 106 being movable with respect to the encoder plate 108. An Example is shown in FIG. 6. In alternative embodiments, the object 110 may be secured to either the encoder plate 108 or the set of optical launches 106, whichever is movable, such that the object 110 moves with and in proportion to either the encoder plate 108 or the set of optical launches 106, whichever is movable.

In one embodiment, a reflective encoder 100 (such as the one shown in FIG. 1) may be single-ended with one optical port. Such an encoder 100 may be used at the end of an optical chain or branch. In another embodiment, a transmissive encoder 100 (such as the one shown in FIG. 5) may be double-ended with two optical ports. Such an encoder 100 may be used in the middle of an optical chain (in-line).

In alternative embodiments, the encoder 100 may be absolute (measuring the absolute position or motion of the encoder plate 108 and object 110) or incremental (measuring the relative motion or position of the encoder plate 108 and object 110). The track patterns and signals used to implement such embodiments are known to those of skill in the art.

In alternative embodiments, the encoder 100 may be used to sense the position, motion, direction of motion, velocity, and acceleration of an object 110, including linearly or rotationally. The encoder 100 may utilize no electrical components in the encoder proper, and the signal sent to and returned by the encoder 100 may be a light beam rather than an electrical signal. The encoder 100 may be used in applications that include, but are not limited to: high-intensity EMI/RFI environments where conventional electronic equipment may be subject to interference; long runs of cable where noise or signal loss is a concern (single mode fiber may have very low loss); environments involving very high voltages, including power substations; environments involving ionizing radiation, including nuclear reactors; electromagnetically sensitive environments; environments with high magnetic fluxes, including MRI systems; and environments that require intrinsic safety, including explosion-proof and energy-limited environments.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. An optical encoder comprising:
a first wavelength division multiplexer;
a first set of optical launches comprising at least one optical launch, operatively connected to the first multiplexer; and
an encoder plate comprising at least one patterned track;
wherein each optical launch of the first set is positioned to direct light at the corresponding patterned track.

2. The optical encoder of claim 1:
wherein either:
a. the encoder plate is stationary and the first set of optical launches is movable with respect to the encoder plate; or
b. the first set of optical launches is stationary and the encoder plate is movable with respect to the first set of optical launches; and
wherein an associated movable object is secured to, and moves proportionally to, one of the encoder plate and the first set of optical launches, whichever is movable.

3. The optical encoder of claim 2, wherein the at least one patterned track comprises reflective and absorptive surfaces that reflect or absorb, respectively, light directed from each corresponding optical launch.

4. The optical encoder of claim 3:
wherein the first multiplexer comprises:
a first port; and
a second port comprising at least one channel, wherein the number of channels is equal to the number of optical launches;
wherein the first multiplexer is configured to:
a. receive a beam of light in the first port;
b. separate the beam of light into a number of light slices, where the number of light slices is equal to the number of channels;
c. transmit each light slice out of the second port to the corresponding optical launch;
d. receive each reflected light slice in the second port from the corresponding optical launch;
e. recombine the reflected light slices into a recombined beam of light; and
f. transmit the recombined beam out of the first port.

5. The optical encoder of claim 4, wherein the encoder plate is a rotational disc and wherein movement of the movable object is rotational.

6. The optical encoder of claim 4, wherein the encoder plate is a linear strip and wherein movement of the movable object is linear.

7. The optical encoder of claim 4, wherein patterns of the at least one patterned track are configured such that the encoder plate is coded for binary code or Gray code.

8. The optical encoder of claim 4, wherein patterns of the at least one patterned track are configured such that the optical encoder is an incremental encoder or an absolute encoder.

9. The optical encoder of claim 2 further comprising:
a second wavelength division multiplexer; and
a second set of optical launches comprising at least one optical launch, operatively connected to the second multiplexer;
wherein the at least one patterned track comprises transmissive and absorptive areas that transmit through the encoder plate or absorb, respectively, light directed from each corresponding optical launch of the first set of optical launches;
wherein each optical launch of the second set is positioned to receive transmitted light from the corresponding patterned track of the encoder plate; and
wherein:
a. if the first set of optical launches is stationary, then the second set of optical launches is stationary; and
b. if the first set of optical launches is movable, then the second set of optical launches is movable with the first set of optical launches.

10. The optical encoder of claim 9, wherein:
the first multiplexer comprises:
a first port; and
a second port comprising at least one channel, wherein the number of channels is equal to the number of optical launches of the first set of optical launches;
the first multiplexer is configured to:
a. receive a beam of light in the first port;
b. separate the beam of light into a number of light slices, where the number of light slices is equal to the number of channels; and
c. transmit each light slice out of the second port to the corresponding optical launch of the first set of optical launches;
the second multiplexer comprises:
a third port comprising at least one channel, wherein the number of channels is equal to the number of optical launches of the second set of optical launches; and
a fourth port; and
the second multiplexer is configured to:
a. receive each transmitted light slice in the third port from the corresponding optical launch of the second set of optical launches;
b. recombine the transmitted light slices into a recombined beam of light; and
c. transmit the recombined beam out of the fourth port.

11. The optical encoder of claim 10, wherein the encoder plate is a rotational disc and wherein movement of the movable object is rotational.

12. The optical encoder of claim 10, wherein the encoder plate is a linear strip and wherein movement of the movable object is linear.

13. The optical encoder of claim 10, wherein patterns of the at least one patterned track are configured such that the encoder plate is coded for binary code or Gray code.

14. A system comprising:
a light source;
the optical encoder of claim 4 connected to the light source by an optic fiber; and
a detector connected to the optic fiber;
wherein the light source is configured to generate the beam of light that is received by the first port of the first multiplexer of the optical encoder; and
wherein the detector is configured to:
a. receive the recombined beam of light that is transmitted out of the first port of the first multiplexer of the optical encoder; and
b. determine from the recombined beam a position or movement of the associated movable object.

15. The system of claim 14, wherein:
the detector comprises:
a third wavelength division multiplexer comprising a fifth port and a sixth port comprising at least one channel;
a third set of optical launches comprising at least one optical launch, operatively connected to the sixth port of the third multiplexer; and
an interrogator;
the third multiplexer is configured to:
a. receive the recombined beam of light in the fifth port;
b. separate the recombined beam into light slices; and
c. transmit each light slice out of the sixth port to the corresponding optical launch of the third set of optical launches; and
the third set of optical launches is configured to transmit the light slices to the interrogator.

16. The system of claim 15 further comprising a fiber Bragg grating sensor positioned in the optic fiber;
wherein the interrogator is configured to:
a. determine from the light slices transmitted by the third set of optical launches the position or movement of the associated movable object; and
b. interrogate the fiber Bragg grating sensor.

17. A system comprising:
a light source;
the optical encoder of claim 10 connected to the light source by a first optic fiber; and
a detector connected to the optical encoder by a second optic fiber;
wherein the light source is configured to generate the beam of light that is received by the first port of the first multiplexer of the optical encoder; and
wherein the detector is configured to:
a. receive the recombined beam of light that is transmitted out of the fourth port of the second multiplexer of the optical encoder; and
b. determine from the recombined beam a position or movement of the associated movable object.

18. The system of claim 17, wherein:
the detector comprises:
a third wavelength division multiplexer comprising a fifth port and a sixth port comprising at least one channel;
a third set of optical launches comprising at least one optical launch, operatively connected to the sixth port of the third multiplexer; and
an interrogator;
the third multiplexer is configured to:
a. receive the recombined beam of light in the fifth port;
b. separate the recombined beam into light slices; and
c. transmit each light slice out of the sixth port to the corresponding optical launch of the third set of optical launches; and
the third set of optical launches is configured to transmit the light slices to the interrogator.

19. A method comprising the steps of:
a. providing:
a light source;
the optical encoder of claim 4;
a detector; and
a movable object;
b. securing the movable object to one of the encoder plate and the first set of optical launches, whichever is movable;
c. connecting the light source to the optical encoder by an optic fiber;
d. connecting the detector to the optic fiber;
e. generating the beam of light from the light source and transmitting the beam of light to the first multiplexer through the optic fiber;
f. separating the beam of light with the first multiplexer into light slices;
g. transmitting the light slices out of the first multiplexer through the first set of optical launches onto the encoder plate patterned tracks;
h. absorbing into the encoder plate the light slices that are directed onto the absorptive surfaces of the encoder plate;
i. reflecting back to the respective optical launches the light slices that are directed onto the reflective surfaces of the encoder plate;
j. transmitting to the first multiplexer the reflected light slices from the first set of optical launches;
k. recombining the reflected light slices into the recombined beam of light with the first multiplexer;
l. transmitting the recombined beam out of the first multiplexer to the detector through the optic fiber; and
m. determining with the detector a position or movement of the movable object based on the recombined beam.

20. The method of claim 19 further comprising step:
n. determining with the detector a characteristic chosen from the group consisting of:
1. direction of motion of the movable object;
2. velocity of the movable object; and
3. acceleration of the movable object.
